(19) United States
(12) Patent Application Publication
(10) Pub. No.: US 2014/0348594 A1
(43) Pub. Date: Nov. 27, 2014

(54) FIRE, DUST AND EROSION SUPPRESSION PRODUCT AND METHOD

(71) Applicant: Dan Dwight Sinclair, Scottsdale, AZ (US)

(72) Inventor: Dan Dwight Sinclair, Scottsdale, AZ (US)

(21) Appl. No.: 14/239,250

(22) PCT Filed: Aug. 16, 2012
(86) PCT No.: PCT/US2012/051238

§ 371 Date: Jun. 26, 2014

Related U.S. Application Data
(60) Provisional application No. 61/523,984, filed on Aug. 16, 2011.

(51) Int. Cl. A62C 3/02; B08B 17/02; C09K 21/14; E02D 3/00

(52) U.S. Cl. CPC A62C 3/02; E02D 3/00; B08B 17/02; C09K 21/14
USPC 405/263; 169/45

(57) ABSTRACT

A method of preventing burning of flammable materials near a wildfire has the steps of a. providing gluten; b. providing water; c. mixing the gluten and the water to produce a gluten-water mixture; d. providing a sprayer; e. placing the gluten-water mixture in the sprayer; and f. spraying the flammable materials with an even coat of the gluten-water mixture in sufficient quantity to coat the materials and prevent burning. Gypsum and/or glycerin can be added to the gluten-water mixture. The mixture also can be applied to dusty soil to control dust and erosion.

### TECHNICAL FIELD

The present invention relates to a product and method to suppress fire, dust and erosion, and more specifically to using gluten and/or gypsum and/or glycerin in a combination as a temporary binder.

### BACKGROUND

Fire is looming as a larger and larger hazard, not only because of recent droughts, but also because homes are being built farther and farther away from cities and are encroaching on wild areas. Fires affect 400,000 homes and cause almost seven billion US dollars in direct damage annually in the US. For many years, the Forest Service attempted to immediately quench fires, but this protocol allowed the buildup of flammable leaves and needles, as well as dead trees. More recently the Forest Service has been allowing smaller fires away from populated areas to consume the flammable understory of the forests. However, those fires and planned “controlled” burns can quickly turn dangerous with a shift in the wind.

Many products to suppress fire hazards have been developed. One type of product treats new buildings, and it is Portland cement based and permanent. MONOKOTE® Z-106 and Z0106/HY® are used to fireproof buildings, transportation terminals, convention centers, where the surfaces are relatively clean and free of oil, grease, excess rust, non-compatible primer, etc. MONOKOTE Z-106/G additionally contains gypsum as a binder for use in interior dry environments and has the same surface requirements.

For “long-term” outdoor fire suppression and prevention, PHOS-CHEK® has been used for decades, applied from airplanes, etc. It can also be applied by sprayer at the beginning of fire season and lasts until significant rain. It is recommended for application to the property perimeter and foliage.

In recent years, with increasing construction and droughts, dust suppression has become a major industry. Current methods include frequent water applications and salt application.

### SUMMARY OF INVENTION

In one embodiment there is disclosed a method of preventing burning of flammable materials near a wildfire. The steps include a. providing gluten; b. providing water; c. mixing the gluten and the water to produce a gluten-water mixture; d. providing a sprayer; e. placing the gluten-water mixture in the sprayer; and f. spraying the flammable materials with an even coat of the gluten-water mixture in sufficient quantity to coat the materials and prevent burning.

Alternatively, the method provides gypsum and mixing the gypsum with the gluten and water to produce a gluten-gypsum-water mixture. In another embodiment, the gluten and the water mixture comes from mixing 1 cup of gluten and 1 gallon of water. Alternatively, glycerin can be added to the gluten and water to produce a gluten-glycerin-water mixture. In another embodiment, both gypsum and glycerin are added to gluten.

In another embodiment, there is disclosed a method of stabilizing dusty soil. This method has the steps of a. providing gluten; b. providing water; c. mixing the gluten and the water to produce a gluten-water mixture; d. providing a sprayer; e. placing the gluten-water mixture in the sprayer; and f. spraying the dusty soil with an even coat of the gluten-water mixture in sufficient quantity to coat the soil and prevent dust from blowing.

Alternatively, the method provides gypsum and mixing the gypsum with the gluten and water to produce a gluten-gypsum-water mixture. In another embodiment, the gluten and the water mixture comes from mixing 1 cup of gluten and 1 gallon of water. Alternatively, glycerin can be added to the gluten and water to produce a gluten-glycerin-water mixture.

### DETAILED DESCRIPTION

As the son of a firefighter, I have long studied methods in the field and have been distressed by the uncontrolled destruction of fire and its danger to firefighters. I sought ways to decrease the danger to residents and firefighters by fire suppression and prevention.

Having observed how indestructible dried cereal is attached to a bowl and then its cracking and falling apart, I experimented on different mixtures of cereals (e.g., Cream of Wheat®, etc.) and other components. I arrived at the use of gluten—which has multiple benefits of temporarily coating flammable items but being easily pressure washed off; a natural, renewable product; easy application and protection before fire gets close, water savings (as only enough to carry the gluten is needed); an effective fire barrier; and an excellent fertilizer.

### Gluten

Gluten is named for “glue” because it consists of glutenin proteins that cross-link and increase viscosity, or stickiness. It is present naturally in wheat, corn, barley and rye, where it provides elasticity and after baking a chewy texture. In its natural form it is a composite of gliadin and a glutelin which are only soluble in alcohol, dilute acids and alkalis, unlike its accompaniment starch that is water soluble. Because of these properties, gluten is easily separated from the starch which is washed away with water or saline solution. Before use, gluten is dried and milled to a fine powder. Gluten has been identified as the cause of wheat food allergies and celiac disease, and commercial production of gluten-free flour has grown, with the attendant increase in gluten availability for use in animal food, etc. Very important for my purposes is that gluten has a very high R value (resistance to heat), that it is a renewable resource and that it is nutritional.

Gluten has a very long shelf life in storage, for example, 12 years before use in baking. This feature provides added convenience for the homeowner and others because they can store the product on site and add water before spraying, whether it is stored for weeks or several years.

### Gypsum

Gypsum is a common, very soft sulfate mineral which is calcium sulfate dihydrate (binding two molecules of water per calcium sulfate). It is moderately water soluble and when heated loses liquid water to evaporation. Until now, its major use has been in drywall, fertilizer and plaster. Gypsum is obtained from mining and recycling of drywall. Also electric power stations burning coal with gas desulfurization produce large quantities of gypsum. Gypsum also has a long shelf life and a relatively high R factor. For example, gypsum in one-half-inch thick drywall is known to resist fire damage for an hour.

### Glycerin

Glycerol is a common liquid that is used in many ingested products because it is nontoxic. It is soluble in water, adsorbs water and is a thickening agent. It can be made from a number of feedstocks and is a waste product of biodiesel. It too has a long shelf life and high R value.

For my initial fire prevention efforts, I have employed gluten from Cargill, the VWG blend, in 2000-pound totes for fire prevention services and in 50-pound bags for consumers. Other blends of gluten can be used and obtained from other suppliers. I have found no difference in gluten obtained from different grains. Food-grade gluten is widely available and is preferred because the coating remains in the yard and on the dwelling for extended periods—when it could be ingested by pets or children.

Gluten can be applied dry or wet, as a water mixture. Gluten should be applied evenly but not in excess, which will be difficult to remove later. While the sprayed gluten is naturally gray to white and blends with most outdoor colors, I have found that I can add coloring so that the gluten mix is less noticeable, as is desirable in artificial locations, including but not limited to resorts and as movie sets requiring fire protection.

As mentioned above, gluten is poorly soluble in water, so a little flour can be added to the mixture to better dissolve the gluten in water. Gluten mixed with water only provides superior fire prevention. In one embodiment, the gluten used was a USDA-certified product of wheat and all natural. I found that gluten when mixed with water became a strong binder, a contact tacky substance, and can be removed with water on demand or naturally by rainfall.

For common use in fire prevention, I added about 1 cup of gluten to a gallon of water and then used a common garden sprayer to spread the mixture on the surrounding grounds and on the dwelling itself. The mixture also can be applied from an aerial source, such as a plane, a helicopter or drone. Adding more gluten to the water or spraying additional layers of the gluten water mix on the same surface increased the protection time from fire heat from about one half hour to several hours.

When I have returned days to weeks later to observe plants that I previously sprayed with the gluten mixture, I was pleasantly surprised to see abundant growth and even new growth which I attributed to the nutritious nature of the gluten. On other parts of the same plant that were not coated, there was no new growth (as would be expected during the dry fire season). I even observed tree growth that was unexpected. This indicates that not only was fire retarded, but the gluten mixture was nontoxic and even promoted growth.

My next generation fire prevention product had gypsum in addition to gluten. Gypsum is widely available and innately contains a small amount of water, which when exposed to the heat of a wildfire passing over, evaporates and helps cool the underlying flammable material. Gypsum also made the product more spreadable. One mixture utilized three quarters of a cup of gypsum and one cup of gluten in about one gallon of water. Of course, the amount of gypsum can be varied, with more or less gluten, according to availability and pricing of the commodities. Gypsum can be present at one half cup or one quarter cup or other specific amounts that provide the same advantages of dissolution, easy spreading and fire resistance. A dry coating of about one eighth inch thickness is preferred. More binder results in thicker coating that is longer lasting.

I have tried the same gluten-water mixture on dusty roads and construction sites and it has been successful. Moreover, rain actively aided gluten penetrating deeper into desert soil for better dust and erosion control. However, I wanted a product that would more effectively suppress dust movement for longer periods. I experimented with my 1 cup gluten to 1 gallon water and eventually decided to try adding glycerin to the mixture. I added 1 cup of glycerin to the gallon of water and varied the gluten by one fourth to one cup per gallon. I also tried various ratios of glycerin to gluten: with one part gluten, I used 5, 1, and 0.1 parts of glycerin. I found that the increased glycerin reduced clumping of the mixture. Furthermore, the glycerin appeared to increase the elasticity of the dried gluten. Because dried gluten can be brittle, its effectiveness on roadways is limited. However, with glycerin, the dried glycerin-gluten mixture held up much better. Other advantages of the incorporation of glycerin are deeper penetration, slower drying rate and increased flexibility. In one trial where one side of the road was untreated, that side remained dusty, but the other treated side had no visible dust.

In another embodiment, one of the mixtures is prepared and is ready to spread automatically. Once, there is detection of a nearby fire, one or more servomotors can be activated to dispense product ahead of a fire.

### EXAMPLE 1

### Gluten and Concrete Mixture

I tested gluten in combination with MONOKOTE Z-106 to replace at least some of the 100% Portland cement binder. This mixture of gluten and cement required only very small additions of water for mixing. The resulting mixture afforded user friendly, low pumping pressures and the use of small diameter hoses for increased maneuverability. This innovation provided greater pumping distances for property owners to dispense product and protect their property assets for a nontoxic environmental friendly fire retardant.

An alternative was use of a gluten mixture for fire containment, erosion control and dust control. For example, gluten-based fire retardant was spread along highways and roads, unpaved roads and the shoulders to prevent careless thrown cigarettes from catching brush on fire and simultaneously suppressing dust.

I observed that MONOKOTE Z-106 and the gluten mixture afforded the same level of protection and physical performance. Thus, it would appear that both MONOKOTE and gluten mixtures provide the same high quality, in-place performance characteristics as to fire prevention.

Using gluten in the approved USDA form allowed a permanent fire retardant to be temporary, as the gluten detached with normal rainfall or our water application.

### EXAMPLE 2

### Controlled Burn

Even though MONOKOTE has been well established as the top fire prevention compound in the industry, and was initially a primary ingredient with gluten, we are still very excited to put gluten to the test. First and foremost, we wanted our product to prove its superiority under real conditions and demonstrate its ability to attach itself to fire consumable elements until no longer needed. Once we proved this to the public by way of demonstrations and media reporting, we would then show how we easily remove the applied gluten from the elements it protected. Finally, we wanted to confirm how the dissolved residue, both organic and biodegradable, dissipated as if it were never there at all. These, accomplishments in summary, are what we would realize with a large scale controlled burn.

The entire controlled burn process is paramount to demonstrating the high value of gluten and admixtures and will be well worth the expense. We expect to get concurrence to have a controlled burn close to the time frame we begin marketing the mixture to the public. Until then, planning is the key to its eventual success.

First however, it must be understood that a controlled burn of this nature requires a massive coordinated effort. The media, fire fighting teams, trained employees, government officials (federal, state and county) as well as various other individuals must all be invited and their appearance assured. Next, an area of forest, large enough to constitute a valid test, must be selected and permission obtained from the required government agencies.

We must also procure two like structures (one to be coated with a gluten admixture and the other one left uncoated (the control)) and have them built on or delivered to the controlled burn site. Next, we will need to have three tanker trucks (each about the size of a dump truck) on hand and modified to be able to spray and coat the fire consumable structures on the controlled burn site. We will also need enough of the gluten admixture product to keep these trucks working and in use during the burn. Three water trucks of equal size are required when the controlled burn is over.

How to mix gluten and have it applied during the burn requires a training effort with the tanker truck contractors and prudently the firefighters. Training the firefighters further conveys our intention to supply fire departments all over the world, once we are on the market. I will take personal charge of selecting the tanker truck contractors and develop the training requirements for inclusion into this training program.

Determining the correct number of firefighting crews expected, government agencies, and various other individuals will be the task of an experienced individual, such as the controlled burn coordinator in charge of operations for Arizona's Special Operations. This individual is also in charge of coordinating the technical aspects as outlined in Arizona's Special Operations regulatory requirements for controlled burns.

Although specific embodiments have been illustrated and described herein, those of ordinary skill in the art will appreciate that any arrangement calculated to achieve same purposes can be substituted for the specific embodiments shown. This disclosure is intended to cover any and all adaptations or variations of various embodiments of the invention. It is to be understood that the above description has been made in an illustrative fashion, and not a restrictive one. Combinations of the above embodiments, and other embodiments not specifically described herein will be apparent to those of skill in the art upon reviewing the above description. The scope of various embodiments of the invention includes any other applications in which the above structures and methods are used. Therefore, the scope of various embodiments of the invention should be determined with reference to the appended claims, along with the full range of equivalents to which such claims are entitled.

In the foregoing description, if various features are grouped together in a single embodiment for the purpose of streamlining the disclosure, this method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus the following claims, and such other claims as may later be added, are hereby incorporated into the description of the embodiments of the invention, with each claim standing on its own as a separate preferred embodiment.

1. A method of preventing burning of flammable materials near a wildfire, the method comprising
a. providing gluten;
b. providing water;
c. mixing the gluten and the water to produce a gluten-water mixture;
d. providing a sprayer;
e. placing the gluten-water mixture in the sprayer; and
f. spraying the flammable materials with an even coat of the gluten-water mixture in sufficient quantity to coat the materials and prevent burning.

2. The method of claim 1 further comprising the steps of providing gypsum, mixing the gypsum with the gluten and water to produce a gluten-gypsum-water mixture.

3. The method of claim 1 wherein mixing the gluten and the water comprises mixing 1 cup of gluten and 1 gallon of water.

4. The method of claim 1 further comprising the steps of providing glycerin, mixing the glycerin with the gluten and water to produce a gluten-glycerin-water mixture.

5. The method of claim 1 wherein both glycerin and gypsum are added to the gluten.

6. A method of stabilizing dusty soil, the method comprising
a. providing gluten;
b. providing water;
c. mixing the gluten and the water to produce a gluten-water mixture;
d. providing a sprayer;
e. placing the gluten-water mixture in the sprayer; and
f. spraying the dusty soil with an even coat of the gluten-water mixture in sufficient quantity to coat the soil and prevent dust from blowing.

7. The method of claim 6, wherein the method also promotes fire retardation in the sprayed area.

8. The method of claim 6 further comprising the steps of providing gypsum, mixing the gypsum with the gluten and water to produce a gluten-gypsum-water mixture.

9. The method of claim 6 wherein mixing the gluten and the water comprises mixing 1 cup of gluten and 1 gallon of water.

10. The method of claim 6 further comprising the steps of providing glycerin, mixing the glycerin with the gluten and water to produce a glycerin-gypsum-water mixture.
